(19) United States
(12) Patent Application Publication
(10) Pub. No.: US 2003/0233422 A1
(43) Pub. Date: Dec. 18, 2003

(54) Method and apparatus for creation, publication and distribution of digital objects through digital networks

(76) Inventors: Andras Csaszar, Cupertino, CA (US); James J. Spencer, San Francisco, CA (US)

Correspondence Address: GLENN PATENT GROUP, 3475 EDISON WAY, SUITE L, MENLO PARK, CA, 94025, US

(21) Appl. No.: 10/461,127

(22) Filed: Jun. 12, 2003

Related U.S. Application Data
(60) Provisional application No. 60/388,600, filed on Jun. 12, 2002.

(51) Int. Cl. G06F 15/16

(52) U.S. Cl. 709/206

(57) ABSTRACT

The invention provides a generalized tool for information publishing and personal communication that is not limited to a dedicated purpose. The invention improves the processes associated with the creation, review, alteration, distribution and publishing of a compound derivative digital object capturing information on referred content accessible to users on an electronic information network and comprises any of the relevant characteristics of the referred content, such as its name, headline, content excerpt or sample, thumbnail-size illustration, link to network location. In particular, the invention provides an apparatus and method for easy capturing of such characteristics of referred content in a derivative digital object, altering its components and storing or transferring such derivative digital object, in the form expressed in a flyer metaphor, to other users of the electronic information network. Another embodiment of the invention describes the creation of digital objects based on user-defined content components and the combination of user-defined content components with derivative components obtained through the capturing process. In other embodiment of the invention provides means for annotation of the digital object by its publisher, sender or recipient, whereby personal notes, ratings, category labels, association links are attached to the digital object and the resulting compound digital object, expressed in a flyer metaphor, is stored on a network server in a limited or unlimited fashion for access and use by other network users.

### CROSS REFERENCE TO RELATED APPLICATIONS

This application claims benefit of U.S. Provisional Application No. 60/388,600, filed Jun. 12, 2002.

### BACKGROUND OF THE INVENTION

1. Technical Field

The invention relates generally to information storage, retrieval and communication. More specifically, the invention relates to the creation, publication and distribution of digital information through networked technical devices, for instance computer networks or telephone networks. Further, the invention relates to a compound digital object for use in information publishing and personal communications.

2. Description of the Prior Art

Networks, formed by multiple devices interconnected by digital lines of communication, play an ever more important role in all areas of information storage, retrieval, publishing, distribution, and communication. While there are many different ways networks can be used, practical development of these networks, e.g. the use of enterprise-wide local area networks, wireless telephone systems, or the Internet, has resulted in the development of a number of well-defined specific uses. Besides general computing tasks, information storage, and archiving, networks are also extensively used for one-to-one and one-to-many communication arrangements, most importantly in areas of:

Content Publishing—to make digital content available to users on publicly accessible devices, e.g. network servers);

Public Messaging (Bulletin Boards)—to provide facilities for posting digital messages on networked devices where these messages are publicly accessible for other users;

Personal Communication, such as telephone voice announcement systems, electronic mail, instant messaging, chat rooms, voice communication, and message systems—to build digital platforms for the purpose of exchanging personal messages between individuals or select groups of individuals; and

Information sharing and data transfer—to exchange data files between devices using file transfer utilities, shared filing systems, and server uploads.

Various specialized applications have been developed to support these specific uses on the server side and the client side of the network.

On the server side there are on-line databases, Web servers, bulletin board servers, and other software products to organize digital information in networked computers. Management programs access the stored digital information and act as intermediaries between databases and client computers. Electronic mail nodes, instant message centers, and chat room facilities receive, store, and forward personal messages between individuals and select groups.

On the client side there are Web browsers to facilitate user connection to various Web servers and display the received digital information in perceptible. e.g. visual and audible, form; news group clients to help users review and post messages on publicly accessible bulletin boards; electronic mail utilities, instant messengers, chat room clients, hardware-embedded software, and other interactive user programs to facilitate communication between the system, on the one hand, and individual users and user groups on the other.

Network use often involves messages where the relevant content may not be limited to, or even included in, the message that is transferred from the sender to the addressee. In these cases part of the referred content may reside at one or more remote locations accessible through the network. For instance, a personal message sent by a user to an addressee often carries, in addition to the sender's personal note, one or more pointers to other pieces of content that is published at certain other locations on the network. The recipient of the e-mail message may then use these pointers, e.g. by clicking on active hyper-links embedded in the text message, to visit those network locations—in fact, to request data transfer from those network locations—and review the content referred to by these pointers. With the growth of publicly accessible content made available through network connections, and because of the benefits for all participants, including sender, addressee and publisher, this type of referential communication is becoming more and more ubiquitous.

Tasks often involve several different types of user interaction and, consequently, they require several different client applications. For instance, having encountered an interesting Web page while browsing the World Wide Web, the user may want to bookmark the page so that it would be easier for him, and possibly other interested persons, to revisit the page at a later time. Although this interaction is well-supported by the Web browser itself, when the user wants to share his experience with another network user by sending the bookmark through electronic mail, he must go thorough a multi-step sequence of actions. First, the user copies the address (URL) of the content page. Then he switches to another specialized client-side application, i.e. the e-mail program, pastes the URL into the message body, possibly adds his personal comments to the message, and finally sends the composed message to the second network user.

Making the same pointer and personal comments available to other users who normally use different means of communication, e.g. some of the existing instant messaging services instead of electronic mail, would require that the sender repeats the sequence once again, this time with the use of another client application, the instant message program. An even more cumbersome process would be necessary if the user wanted to include the pointer in his list of favorite Web sites on his personal home Web page. The process would now involve the use of a Web page editor—to add the new link to the HTML file of the user's home page—then the use of a file transfer program to upload the updated file to the Web server.

The rigid boundaries between the creation, broadcasting, publishing, and public messaging, on the one hand, and personal communication on the other, become more and more blurred. Digital communication provides a viable basis for various novel forms of flexible and complex information exchange that were earlier impractical using traditional means. Based on electronic communication facilities, mailing lists, or on-line bulletin boards, individuals who earlier communicated mostly with single addressees can now distribute their messages to a larger number of interested persons expanding the scope of their personal communication. On the other end of the communication spectrum, entities who earlier had to resort to impersonal broadcasting forms to disseminate their content, now may use the new distribution means to target a smaller, but more relevant audience, thereby narrowing and focusing the horizon of their broadcasting and improving its impact.

State of the art client applications are currently limited to certain specific functionality, i.e. sending and receiving e-mail, but not for modifying personal Web pages, or for supporting instant messaging between users, but not for browsing the network and reviewing content. While more complex and feature-rich client applications would certainly suite users, the wide use by millions of people of the established client applications makes the introduction of more integrated applications and feature-rich clients impractical.

As discussed above, it is known to use an electronic information network, such as the Internet, to send messages to one or more recipients and to browse for information. For example, a person reading an article on a Web site can email that article to a friend by either sending the friend a link to the article in an email message, or by pasting the article into the email message body. This ability to send information is not limited to Web sites, and any electronic file may be either identified by sending a link thereto or by pasting the file into an email message. Recently, instant messaging has also been used for similar purposes.

Modern Web browsers allow a person to view information contained on a Web page and to click on various links in such Web pages to view additional Web pages, files, or other electronic information to which such links lead. A Web page may also contain a form that allows a person to identify a recipient of information, which information may be sent to the recipient as outlined above.

For example, a person may visit a greeting card Web site, such as DaySpring Cards (dayspring.com), and send an electronic greeting card to a friend. The greeting card may be sent either as an email message containing the greeting card, for example an email message that includes HTML, JPEGs, and the like, or it may contain a link to a Web page which, when clicked, invokes the recipient's browser and takes the recipient to a Web page which contains the personalized greeting card for the recipient. Day Spring Cards send an email message containing a link. The link leads to a Web page that displays an image of a postcard, including To: and From: fields, simulated postage, and a simulated post office cancellation mark (see FIG. 1). Clicking on the NEXT button takes the recipient to one or more pages of drawings, photos, text, and the like, accompanied by music, which comprise the greeting card itself.

One disadvantage of such Web sites as DaySpring cards is that they are dedicated to a special purpose, e.g. electronic greeting cards. Thus, the ability to send a personalized message or other information is limited in such Web sites to the special purpose of the Web site. Accordingly, any tools that may be used for such purposes as personalized messages in connection with various sources of information are inextricably integrated with a few types of dedicated Web sites, and their functionality is inseparable therefrom for uses apart from those found in connection with the dedicated Web site. Thus, a user may not access a greeting card site to forward information to a friend that is not a greeting card, nor can the tools provided by the greeting card site be used for purposes other than the sending of a greeting card. Accordingly, the only generalized way of sending information and personal communications, other than the use of a dedicated Web site, is through the above-described mechanisms of sending a link with an email message or pasting information into the body of an email message.

What is needed to a generalized tool for creation, storage, publication and distribution of digital objects in association with referred content accessible on the network.

### SUMMARY OF THE INVENTION

The invention provides a generalized tool for creation, storage, publication and distribution of digital objects in association with referred content accessible on the network that is not limited to a dedicated purpose.

In one embodiment, the teachings described herein improve the processes associated with the creation, review, alteration, and distribution of digital messages. In particular, the invention provides, through the use of a combination of server-side and client-side functionality a method that lets a user:

experience the publicly available content (Primary Objects) on the network and easily capture, in the form of Derivative Digital Objects, relevant characteristic attributes, for instance pointers to the location of the Primary Digital Object, its name or headline, text excerpt, illustration, audio sample, or other representative component, from those Primary Digital Objects;

express the user's comments, recommendations, evaluation, or other opinion regarding the Primary Digital Object by recording additional components of personal origin as part of the Derivative Digital Object or create new Derivative Objects based primarily on user-generated components; and also combine multiple Derivative Objects in Compound Derivative Objects where the combination of these Derivative Objects expresses certain additional user-provided information, for instance thematic grouping, quality judgment, personal preference, or other unifying concept; and

exchange the captured information with other network users by posting the Derivative Object or the Compound Derivative Object on the derivative object server and thereby making it accessible through the network, and also by sending the Transfer-Form Derivative Object to one or more Addressees through selected distribution mechanisms, such as communication systems, for instance electronic mail, instant messaging, telephone, wireless communication, local area networks, and thereby providing these Addressees with personalized information regarding the Primary Object and also directing these Addressees, through pointers embedded in the Transfer-Form Derivative Object, to the original Primary Object.

In another embodiment, the invention provides an advertisement medium where the impact of the advertiser's message is amplified by the distribution of such messages combined with personal user opinion.

In another embodiment, the invention provides a multi-purpose collaborative information platform where members of the collaborating group share personal information combined with reference information that points to publicly accessible content on the network.

Yet another embodiment, whose software is made available on the Internet, allows users to customize their browser to enable greater efficiency to experience and exchange information. The user may choose to download an application that combines previously separate email applications into a simple, one-click, right-click service that immediately launches communications menus that allows the user to instantly send and respond to emails.

These and other operations are accomplished by providing for creation, based on Primary Digital Objects accessible through the network, review and alteration, through authenticated user terminals, and distribution, with the use of one or more derivative object servers connected to the network, of Derivative Objects and Compound Derivative Objects.

A further embodiment of the invention provides a network-based system that allows creation, storage and distribution of digital objects that employ a flyer or postcard metaphor. The flyer is a compound digital object that may include: descriptive text elements, illustrative images, numeric descriptors, and other possible digital components. Additionally the flyers may be standalone, or a leading flyer may be associated with one or more fleet member flyers that are united by a common theme. The flyer may be branded, exposing viewers to the publisher's name, likeness, logo, etc. as they manipulate and interact with the flyer. The flyer incorporates personal customization features, wherein a sender may attach personal notes, ratings and category labels. When received, the sender's identity is revealed to the recipient, creating the perception in the recipient of a personal endorsement of the publisher from the sender. Flyers are created by capturing content from Web pages and are stored in a personal publishing area on the system server. Flyers are distributed and propagated using various means of electronic distribution available from the network.

### BRIEF DESCRIPTION OF THE DRAWINGS

FIG. 1 is a Web page of a greeting card Web site;

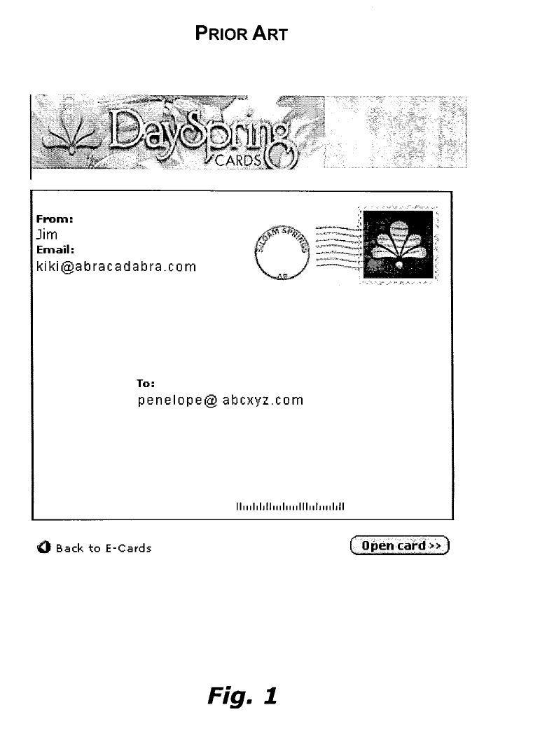

FIG. 2 is a block schematic diagram that illustrates one embodiment of a network system according to the invention;

FIG. 3 is a flow diagram that illustrates one embodiment of a process for creating a Derivative Object by capturing a component set from an existing Primary Object according to the invention;

FIG. 4 is a flow diagram that illustrates one embodiment of a process for creating a new Derivative Object or a Compound Derivative Object (DO or CDO) from user-generated components according to the invention;

FIG. 5 is a flow diagram that illustrates one embodiment of a process for altering an existing Derivative Object (DO) or a Compound Derivative Object (CDO) by user-generated components according to the invention;

FIG. 6 is a flow diagram that illustrates one embodiment of a process for transferring a Derivative Object (DO) or Compound Derivative Object (CDO) to one or more selected addressees via selected distribution mechanisms according to the invention;

FIG. 7 is a schematic representation of a compound digital object, expressed in a flyer metaphor, according to the invention;

### DETAILED DESCRIPTION OF THE INVENTION

In the following description, numerous details are set forth to provide a more thorough explanation of the invention. It will be apparent, however, to one skilled in the art, that the invention may be practiced without these specific details. In other instances, well-known structures and devices are shown in block diagram form, rather than in detail, to avoid obscuring the invention.

Some portions of the detailed descriptions which follow are presented in terms of algorithms and symbolic representations of operations on data bits within a computer memory. These algorithmic descriptions and representations are the means used by those skilled in the data processing arts to convey the substance of their work to others skilled in the art most effectively. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROM's), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the invention is not described with reference to any particular programming language. It will be appreciated that a variety of programming languages may be used to implement the teachings of the invention as described herein.

A machine-readable medium includes any mechanism for storing or transmitting information in a form readable by a machine, e.g. a computer. For example, a machine-readable medium includes read only memory (ROM); random access memory (RAM); magnetic disk storage media; optical storage media; flash memory devices; electrical, optical, acoustical or other form of propagated signals, e.g. carrier waves, infrared signals, digital signals.

Overview

In one embodiment, the teachings described herein improve the processes associated with the creation, review, alteration, and distribution of digital messages. In particular, the invention provides, through the use of a combination of server-side and client-side functionality, a method that lets a user:

experience the publicly available content (Primary Objects) on the network and easily capture, in the form of Derivative Digital Objects, relevant characteristic attributes, for instance pointers to the location of the Primary Digital Object, its name or headline, text excerpt, illustration, audio sample, or other representative component, from those Primary Digital Objects;

express the user's comments, recommendations, evaluation, or other opinion regarding the Primary Digital Object by recording additional components of personal origin as part of the Derivative Digital Object or create new Derivative Objects based primarily on user-generated components; and also combine multiple Derivative Objects in Compound Derivative Objects where the combination of these Derivative Objects expresses certain additional user-provided information, for instance thematic grouping, quality judgment, personal preference, or other unifying concept; and

exchange the captured information with other network users by posting the Derivative Object or the Compound Derivative Object on the derivative object server and thereby making it accessible through the network, and also by sending the Transfer-Form Derivative Object to one or more Addressees through selected distribution mechanisms, such as communication systems, for instance electronic mail, instant messaging, telephone, wireless communication, local area networks, and thereby providing these Addressees with personalized information regarding the Primary Object and also directing these Addressees, through pointers embedded in the Transfer-Form Derivative Object, to the original Primary Object.

In another embodiment, the invention provides an advertisement medium where the impact of the advertiser's message is amplified by the distribution of such messages combined with personal user opinion.

In another embodiment, the invention provides a multi-purpose collaborative information platform where members of the collaborating group share personal information combined with reference information that points to publicly accessible content on the network.

Yet another embodiment, whose software is made available on the Internet, allows users to customize their browser to enable greater efficiency to experience and exchange information. The user may choose to download an application that combines previously separate email applications into a simple, one-click, right-click service that immediately launches communications menus that allows the user to instantly send and respond to emails.

These and other operations are accomplished by providing for creation, based on Primary Digital Objects accessible through the network, review and alteration, through authenticated user terminals, and distribution, with the use of one or more derivative object servers connected to the network, of Derivative Objects and Compound Derivative Objects.

Terminology

Digital Object: Digital Objects form the lifeblood of digital networks. Encoded in digital form, these objects may represent series of presentation slides, text documents, individual images or image collections, audio recordings, motion picture sequences, data tables, mathematical formulas, web pages, computer algorithms, and many other types of information. It its broadest sense this term covers any kind of digitally coded information. Digital Objects are stored and operated upon by digital devices and transmitted between devices through digital communication lines that form a network. A Digital Object may include a single component, such as a Web pointer (universal resource locator, or URL), a single bitmap image, or a simple audio sample. In other cases, they comprise multiple components, such as a Web page that is built of an HTML file and multiple images, or a collection of sound samples representing a library of audio records. Because the communication between devices is virtually instantaneous, the operation on Digital Objects is often possible even when the Digital Objects are initially stored at various distant devices, since it can be downloaded from there to the operating device when necessary.

Primary Digital Object (or Primary Object): The term Primary Digital Object (or Primary Object) in the following discussion is used for a Digital Object that was created by an author or source (usually not the current user of the invention) and is stored at some device location that is accessible through the network. For instance, the HTML code that generates the US Patent Office's Home Page and resides on the Office's web server accessible through the URL: www.uspto.gov is an example of such a Primary Object.

Derivative Digital Object (or Derivative Object): A digital object created by one or more methods taught herein and associated with a Primary Object is a Derivative Digital Object (or Derivative Object). It usually comprises one or more digital components derived from the Primary Object. A Derivative Object may comprise some of the unchanged components of the Primary Object, for instance its title and a text excerpt from the HTML file. A Derivative Object may also comprise some modified components of the Primary Digital Object, for instance, a smaller scale thumbnail version of an image from the Primary Object. Yet in other instances, the Derivative Object may also comprise components that are associated with, but are not explicitly present, in the Primary Object. For instance, a user comment or a quality rating score may be provided by the creator of the Derivative Object and included in the Derivative Object.

Compound Digital Object A Compound Digital Object is a combination of Digital Objects brought together under a unifying concept. Regarding its structure, a Compound Digital Object may include components similar to an individual Digital Object, e.g. name, title or headline, abstract, text description, illustration, sound sample, network pointer, personal comments, quality rating score or other components, plus references to other Digital Objects that are included within the Compound Digital Object. Such a Compound Digital Object, when presented to users as, for example, thematic classes, topical categories, quality evaluations or under other unifying concepts, may provide structure and orient the recipient within the seemingly unorganized world of information. As part of the Web browsing experience, for instance, a Compound Digital Object may take the form of a list of titles and Web pointers (Derivative Objects) named, for example, as the Most Popular Snowboarding Web Sites. In another example, a voice announcement system may, for instance, list the Latest CD Releases (Compound Digital Object), and provide individual song titles presented together with numeric key names (Derivative Objects) that would guide the user to recorded sound samples (Primary Objects) provided through a telephone service. A Compound Digital Object may comprise multiple Digital Objects, or, at least for some periods of time, for instance immediately after the creation of a new Compound Digital Object, such a Compound Digital Object may not comprise any Digital Object other than its own components. Therefore such Compound Digital Object is similar to a stand alone Digital Object. For this reason it is practicable to view the functionality of the invention in such a way that it operates on stand alone Digital Objects as well as Compound Digital objects. For instance, the means provided by the invention for combining stand alone Digital Objects into a Compound Digital Object, would allow the combination of Compound Digital Objects into another other Compound Digital Object. Similarly, in addition to providing means for alteration of components, storage, publishing and transfer of Digital Objects the invention provides means for alteration of components, storage, publishing and distribution of Compound Digital Objects. Therefore wherever the description of the invention refers to operations on Compound Digital Objects, stand alone Digital Objects must also be understood.

Transfer-Form Digital Object (or Transfer-Form Object): A Transfer-Form Object is a Derivative Object formatted appropriately to facilitate its transfer to an addressee through a selected distribution mechanism. The composition of the transfer-form object shall be suitable for displaying the relevant content of the transferred object within a commonly used client application. For instance, if the selected distribution mechanism is e-mail, then the transfer form of a digital object may certainly include one or more text components and possibly even small-size bitmap images taken from the Derivative Object, because the commonly used client application (the e-mail client, in this case) is usually capable of displaying this type of data. On the other hand, it would be impractical to include large movie sequences in the e-mail transfer.

Capturing Process: The term capturing process in the following discussion refers to a process initiated by an authenticated user for the purpose of creating a Derivative Object based on a Primary Object. The process is performed by a combination of a client-side and server-side steps. The capturing process usually involves the isolation by an authenticated user terminal of some components of the Primary Object and then the transfer of a captured component set by the authenticated user terminal to a derivative object server.

Client Application: A client application is a widely used client-side software application employed by the user to perform certain operations on the network. Besides performing certain pre-programmed data processing actions, the client application may (i) display information, that is, present the user with information in visual, audible or otherwise perceptible form, (ii) and/or accept information from the user and (iii) and/or communicate information with other devices through the network. Examples of client application are e-mail clients, Web browsers, instant messaging applications, various hardware-embedded software application that make technical devices, such as telephone equipment, hand-held data processing devices and other equipment fully functional.

Authenticated Client Application: An authenticated client application is a client application that allows access to the available functions described herein. Authentication may, in some embodiments, be done through a registration process where certain personal information from the user is gathered by the system.

Authenticated User: An authenticated user is a user who operates an authenticated client application and therefore has access to the functionality set described herein.

Unauthenticated User: An unauthenticated user is a user who operates a client application that has not been marked by the system as authenticated to access the available functions described herein. In some embodiments, this user usually has access to a limited set of functions described herein. For instance, the unauthenticated user may review a Derivative Objects created previously by an authenticated users and may attach personal comment to such Derivative Objects but is not authorized to create new Derivative Objects or manage a collection of Derivative Objects on his own.

In one embodiment, the authenticated user of the invention has access to the full feature set described herein that enables the user to:

experience the publicly available content (Primary Objects) on the network and easily capture, in the form of Derivative Digital Objects, relevant characteristic attributes, for instance pointers to the location of the Primary Digital Object, its name or headline, text excerpt, illustration, audio sample, or other representative component, from those Primary Digital Objects;

express the user's comments, recommendations, evaluation, or other opinion regarding the Primary Digital Object by recording additional components of personal origin as part of the Derivative Digital Object or create new Derivative Objects based primarily on user-generated components; and also combine multiple Derivative Objects in Compound Derivative Objects where the combination of these Derivative Objects expresses certain additional user-provided information, for instance thematic grouping, quality judgment, personal preference, or other unifying concept; and

exchange the captured information with other network users by posting the Derivative Object or the Compound Derivative Object on the Derivative Object Server and thereby making it accessible through the network, and also by sending the Transfer-Form Derivative Object to one or more addressees through selected distribution mechanisms, such as communication systems, e.g. electronic mail, instant messaging, telephone, wireless communication, and local area networks, and thereby providing these addressees with personalized information regarding the Primary Object and also directing these addressees, through pointers embedded in the Transfer-Form Derivative Object, to the original Primary Object.

Creation, Review, Alteration and Distribution of Derivative Objects and Compound Derivative Objects

The creation, review, alteration, and distribution of Derivative Objects associated with certain Primary Object lie in the core of one embodiment of the invention. In one embodiment, the system described herein supports an authenticated user in his endeavor to create Derivative Objects by various mechanisms, including:

the capturing of component sets from existing Primary Objects,

the creation of new Derivative Objects based on user-generated components, and

the combination of Derivative Objects in Compound Derivative Objects.

An authenticated user may initiate the capturing process whenever his authenticated client application presents a Primary Object. In case of a Web-browsing experience, the user's authenticated client application is connected to a Web page (Primary Object) that the user wishes to revisit later, or make a note of some of the information featured on this page, or wishes to share the page with other users. The capturing process usually captures only a portion of the information contained in the original Primary Object, i.e. a subset of its component set.

From the authenticated user's point of view the capturing process means that the user's authenticated client application, in this example the Web browser, sends the extracts from the component set of the Primary Object certain components and posts these components on the derivative object server. To create a Derivative Object, the operation of the capturing process, however, results in the capturing of at least one component. This component may be derived from the Primary Object or may be generated by the user. The list below shows examples of some of the components the user may find useful to capture or generate. The list is not exhaustive, and none of the components listed here are mandatory in any one capturing event.

The list may include:

the name, title or headline of the Primary Object;

the pointer to the Primary Object, for instance its network address (URL) or telephone number;

one or more text excerpts from the Primary Object;

one or more of the images, or smaller (thumbnail) version of such images, or motion picture sequences;

one or more sound samples performed or referenced by the Primary Object;

one or more pointers included in the Primary Object and pointing to other relevant content components outside of the Primary Object;

an authenticated user's personal ID that is recorded by an embodiment of a system described herein;

an authenticated user's personal comments or other information provided by the authenticated user;

a quality rating score or other evaluation information assigned by the authenticated user's to the Primary Object;

instructions defining the presentation format of the Derivative Object when presented to users through authenticated client applications, for instance page layout display templates;

indication of the desired public or private status of the captured information showing whether the Derivative Object must be made publicly accessible to all network users accessing the derivative object server or shall be kept confidential with access limited to certain users or user groups; and

instructions regarding the transfer of the captured information to one or more addressees, for instance their communication addresses and preferred mechanisms of communication.

As long as it is presented on the derivative object server in a public state, the system may allow the user to perform one or more actions on the Derivative Object, for instance:

review by any user who has access to the system,

comment by any user who has access to the system,

re-capture by any second authenticated user of the system and made part of the collection of Derivative Objects created by this second authenticated user, and

distribute by any of the authenticated users to any addressee using the available communication features of the system.

In the discussed example of the Web browsing experience, the capturing process means that the user's authenticated client application sends to the derivative object server the components captured and possibly altered (edited, added to) by the authenticated user and that on the derivative object server, the component set is stored in the derivative object database, one or more Derivative Digital Objects are created based on the component set and, the Derivative Object is included in at least one Compound Derivative Object residing on the Derivative Object Server.

If the authenticated user sets the publishing status of the Derivative Object to public, the Derivative Object is accessible to users authorized to access the derivative object server. Various other publicity levels can also be defined by the authenticated user limiting access to certain users or groups of users or limiting access to only the authenticated user who created the Derivative Object.

When accessed through an appropriate client application the Derivative Object becomes perceptible to a second user. In the discussed example, for instance, the Derivative Object may be presented in the form of a Web page that is displayed inside the second user's Web browser. Because the Derivative Object possibly includes some captured components derived from the Primary Object and it also might include additional personal information, e.g. comments, quality ratings, evaluation, recorded by the authenticated user who created the Derivative Object, this Derivative Object thereby can provide useful information for the second user to make the decision whether or not to visit the location and review the original Primary Object. The pointer possibly embedded in the Derivative Object also assists the second user to find his way easily to the location where the original Primary Object is stored.

In one embodiment, the invention includes the ability of the system to help users efficiently exchange among themselves, via appropriately selected distribution mechanisms, the Derivative Objects and Compound Derivative Objects. These distribution mechanisms depend on the preferred communication forms used by the potential addressees and also on the nature and format of the objects distributed. The choice of distribution mechanisms may include one or more formats, commonly used for digital network-based communication, including, but not limited to, electronic mail (e-mail), various formats of instant messaging systems (IM), publicly available on-line bulletin boards (BB), network-based shared file systems (copytemp), telephone-delivered audio, small messaging systems (SMS) delivered wireless systems, such as cellular phones, or other communication forms. Recognizing the significant differences between the communication possibilities in various selected distribution mechanisms, one of the implementations of the invention teaches the creation of the Transfer-Form Object, based on the component set of the Derivative Object. The appropriate composition of the Transfer-Form Object makes it possible for the addressee to review the relevant content of the message displayed by his client application. For instance, if the selected distribution mechanism is e-mail, the transfer form of the digital object may include one or more text components and possibly even small-size bitmap images because the commonly used client application, the e-mail client in this case, is usually capable of displaying these information formats. On the other hand, even if the essence of the original Derivative Object is a movie trailer, for instance, it would be impractical to include a large movie sequence in the e-mail transfer because commonly used e-mail environments are not accommodating to the transfer of large files, the client application is also not well equipped to play back such movie files. Or, when the selected distribution mechanisms is a small message system (SMS) implemented on a wireless delivery platform, the use of bitmap images would also be impractical. Even the text components of the original object may need to be shortened significantly to match the character limitations of such SMS systems. As a result of these considerations the component set of the Transfer-Form Object includes usually an appropriately formed subset from the original component set of the Derivative Object. In addition, the Transfer-Form Object also includes relevant access pointer that specify the location of the Derivative Object for the addressee.

When the original Derivative Object or Compound Derivative Object is publicly accessible to all users of the invention, the addressee, guided with the access pointer, is able to find the original Derivative Object or Compound Derivative Object on a derivative object server. However, when the original Derivative Object or Compound Derivative Object is in limited publicity state, which means it is not publicly accessible to all users, the Transfer-Form Object may carry the access pointer that points not to the original Derivative Object, but to a Landing Object, an object similar to the Derivative Object but having unlimited access and therefore is capable of accepting the inquiry of the addressee who follows the direction of the access pointer in search of the Derivative Object.

Those skilled in the art will recognize that the addressee of the Transfer-Form Object may not necessarily be limited to a single recipient, but may also be a group of recipients each with a different communication address, or the addressee can also be an aggregate list of recipients who earlier joined the mailing list. Commonly used procedures exist in the art for the creation, maintenance and use of such lists of addressees.

Functionality

In one embodiment, while dealing with any derivative articles created by himself, the authenticated user has access to a full set of features that enable him to:

review any such Derivative Object and use the embedded pointer of such Derivative Object as a jumping board (bookmark) to access the associated Primary Object;

add to or alter, i.e. edit or remove, his earlier personal information, e.g. comments, quality score, to such Derivative Objects;

create a new Derivative Object by providing text files, images, other digital assets uploaded to the derivative object server from his authenticated user terminal;

create Compound Derivative Objects and include, sort, edit, add to or delete from such Compound Derivative Object or any Derivative Object;

set the status of any such Derivative Object or Compound Derivative Object to various levels of a private state, thus limiting its accessibility, or to a public state, making it accessible for all users;

create and maintain confidential address databases comprising of contact information, e.g. communication addresses, names, preferred mechanisms of communication, for other network users;

create mailing lists by typing in or uploading contact information for potential addressees;

let other users add their own contact information (opt-in) to the mailing lists maintained by the authenticated user; and/or

distribute, through the communication features described herein, any Derivative Object or Compound Derivative Object, whether created by him or by other users, to addressees, e.g. individual members or groups of members.

In addition to the above mentioned operations, the authenticated user has, in respect to Derivative Objects or Compound Derivative Objects created by authenticated users other than himself and accessible to him because of the publicity level of such Derivative Objects or Compound Derivative Objects, access to all functions available for any second authenticated user.

In one embodiment, a second authenticated user, when dealing with any Derivative Object or Compound Derivative Object created by authenticated users other than himself and accessible to him because of the publicity level of such Derivative Objects or Compound Derivative Objects, can:

review any such object and use the embedded pointer of such object (as bookmark) to access the associated Primary Object;

add personal information to such object;

recapture such object and include it in his own collection of Derivative Objects; and

distribute, through the communication features of the invention, any such object to addressees (individual members or groups of members).

In one embodiment, an unauthenticated user, when dealing with any Derivative Object or Compound Derivative Object created by any authenticated user and accessible to him because of the publicity state of such Derivative Object or Compound Derivative Object, can:

review any such object and use the embedded pointer of such object (as bookmark) to access the associated Primary Object; and

distribute, through the communication features of the invention, any such object to addressees (individual members or groups of members).

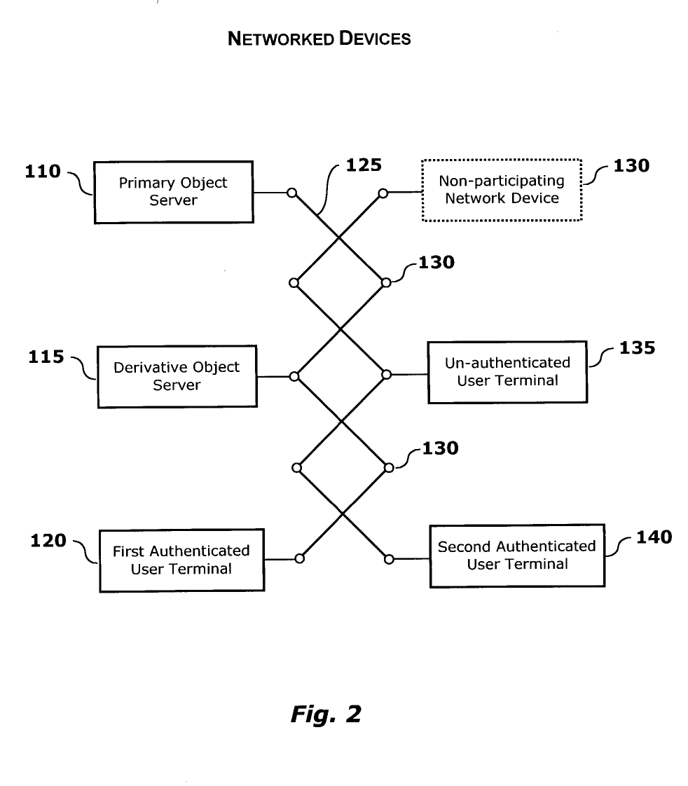

FIG. 2 depicts one embodiment of a network system. In this system, network 125 connects a multiplicity of devices, including the primary object server 110, the derivative object server 115, a first authenticated user terminal 120, an unauthenticated user terminal 135 and a second authenticated user terminal 140. Some other devices connected to the network 125 may, or may not, be involved in the data transfer between the above-mentioned devices, but their role is transparent from the standpoint of processes significant for the invention, hence they are marked in FIG. 2 as non-participating network devices 130.

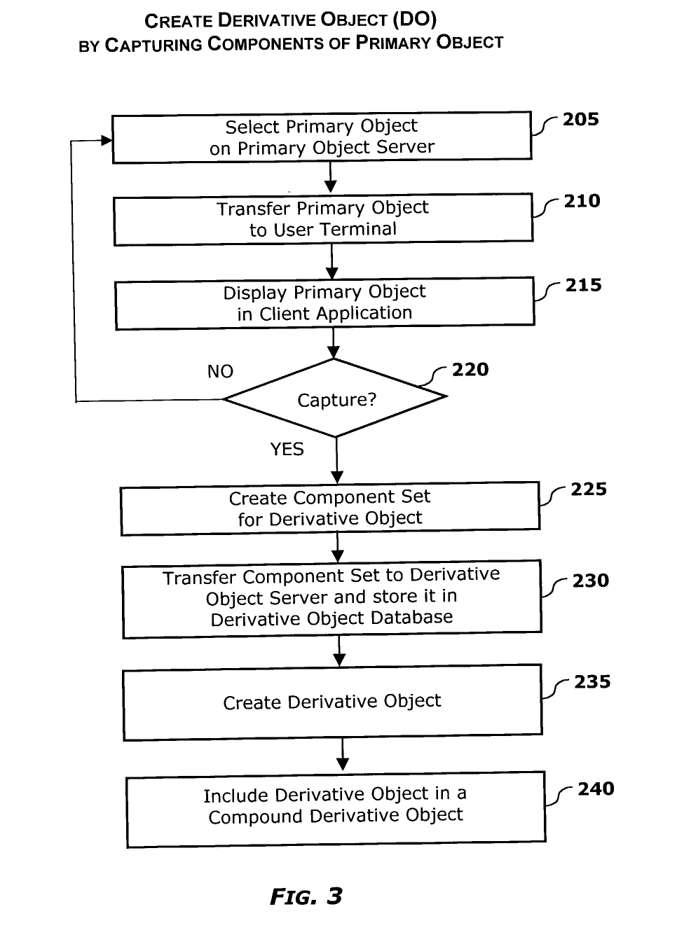

FIG. 3 depicts a flow diagram of one embodiment of a process for creating a Derivative Object by capturing a component set from an existing Primary Object. The process is performed by processing logic that may comprise hardware, e.g., circuitry and/or dedicated logic, software, such as is run on a general purpose computer system or a dedicated machine, or a combination of both.

The process involves the authenticated user terminal 120, the primary object server 110 and the derivative object server 115, all interconnected through the network 125. The process depicted by FIG. 3 results in the creation of a single Derivative Object; it does not result in the creation of a Compound Derivative Object.

The process assumes that at least one Primary Object resides on the primary object server 110 and this Primary Object is accessible to the first authenticated user terminal 120 through the network 125. In processing block 205, the user selects one or more Primary Objects of interest to be transferred in processing block 210 through the network 125 from the primary object server 110 to the authenticated user terminal 120. In processing block 215, the Primary Object is displayed at the first authenticated user terminal 120 by the authenticated client application.

A decision is made in processing block 220 whether or not a new Derivative Object shall be created based on the currently displayed Primary Objects. If the decision is NO, then a closed cycle of steps is formed by processing blocks 205-210-215-220 along the NO branch of the decision making processing block 220. This is the usual navigation cycle, one of the most basic processes in network use, during which a user usually reviews a series of articles, e.g. pieces of accessible information, through the network.

Based on the components of the Primary Object of preference in processing block 225, the component set for the Derivative Object is created by the authenticated client application. Those skilled in the art will recognize that commonly used procedures exist for presenting any or all of the components of Primary Object and letting the user select from such components. For instance, the authenticated client application may let the user highlight part of the displayed text in the Primary Object and thereby identify this portion of text for future use, or select, through a mouse or keyboard action, and identify for future use, any of the pictures displayed as part of the Primary Object. Those skilled in the art will also recognize that similar commonly used interactive procedures exist for letting the user edit some or all of the components derived from the Primary Object. For instance, a mouse or keyboard action can display one or more text components of the Primary Object as part of one or more editable fields, where the user can alter, i.e. change, delete from or add to, the text displayed. The user may, for instance, modify the title of the Primary Object, its text description, its universal resource locator (URL) or other components. Applying similar processes, the user may also add new components (subtitle, comments), or attach one or more illustrations, quality rating measures or others components to the component set for the new Derivative Object. To assist the user in efficiently creating component sets for Derivative Objects, the authenticated client application may use predefined sets or templates for component sets. As such an example, a single mouse or keyboard action may create, without any further user interaction, a predefined component set for the Derivative Object which may include, for instance, the title, the universal resource locator (URL) and one appropriately selected illustration from the Primary Object. The same mouse or keyboard action may also initiate the consecutive process starting with processing block 230. Other less or more complex component sets can also be presented in a list of templates and the user may choose the desired component set from such list by applying a simple selection process.

The component set is transferred in processing block 230 to the derivative object server 115. Processing block 235 stores the component set in the derivative object database at the derivative object server 115.

In processing block 240 the newly created Derivative Object is included in at least one Compound Derivative Object at the derivative object server 115. These Compound Derivative Objects usually serve as convenient forms to present a group of Derivative Objects for review by users. Examples of such Compound Derivative Objects are the general inventory list that features many or all Derivative Objects stored in the derivative object database, or the personal inventory list that includes the Derivative Objects created by one user. Other examples of the Compound Derivative Object in which the newly created Derivative Object is included may be thematic selections that list only Derivative Objects with certain thematic content; collections of Derivative Objects grouped together for future distribution for the review by other users; collections of Derivative Objects based on time of their creation, the profile or name of the individual or entity who created them, and other criteria.

Although FIG. 3 depicts processing block 240 as immediately following processing block 235, in other possible embodiments of the invention processing block 240 may take place at other times, for instance, but not limited to, the time immediately preceding the transfer of a Compound Derivative Object to a user terminal.

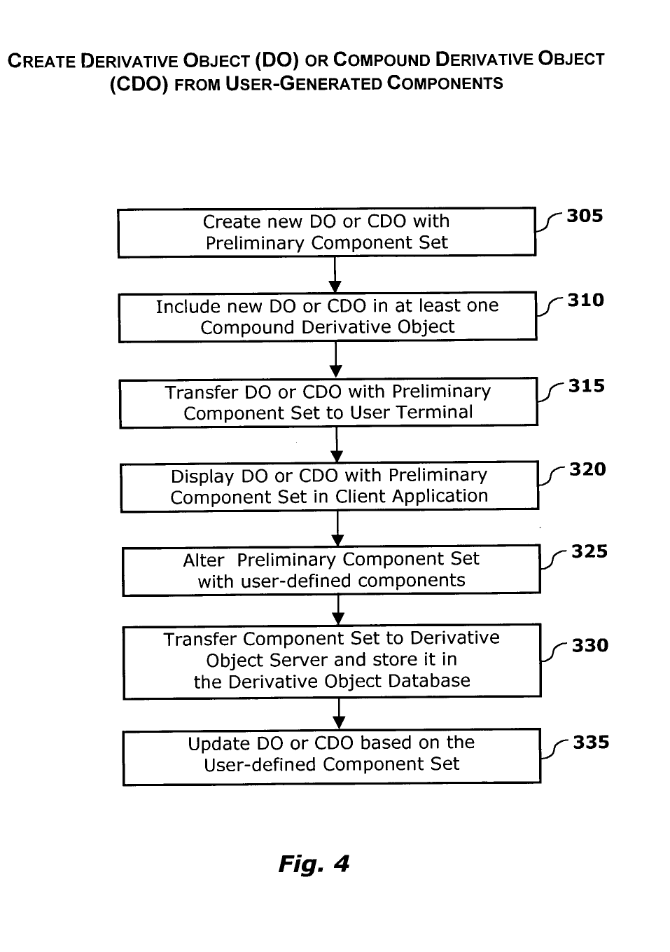

FIG. 4 depicts a flow diagram of one embodiment of the creation of a new Derivative Object or a Compound Derivative Object (DO or CDO) from user-generated components. The process is performed by processing logic that may comprise hardware, such as circuitry and/or dedicated logic, software, such as is run on a general purpose computer system or a dedicated machine, or a combination of both.

The process involves the authenticated user terminal 120, and the derivative object server 115, interconnected through the network 125.

In processing block 305 a Derivative Object or a Compound Derivative Object is created with a preliminary component set on the derivative object server 115. In processing block 310 the Derivative Object or a Compound Derivative Object is included in at least one Compound Derivative Object. In processing block 315 the Derivative Object or a Compound Derivative Object with preliminary component set is transferred—either itself or as part of a Compound Derivative Object that includes the newly created Derivative Object or a Compound Derivative Object with preliminary component set—to the first authenticated user terminal 120 and is displayed, in processing block 320, by the authenticated client application.

In processing block 325, through commonly used procedures known in the art, the user is allowed to alter, e.g. change, delete from or add to, some or all of the components of the preliminary component set for the Derivative Object or Compound Derivative Object. For instance, mouse or keyboard actions can display one or more text components of the object inside editable field or fields, where the user can alter or add to the displayed text, including, but not limited to, the title of the object, its caption, subtitle, abstract, detailed text description, personal comments, universal resource locator (URL) or other text components. Applying further commonly used processes, the user may also add other, non-text components, including, but not limited to, quality rating measures, illustration, animated sequences or audio assets selected from server-side or client-side libraries. When the object currently altered is a Compound Derivative Object, the user may define one or more other Derivative Objects or Compound Derivative Objects to be included in the currently altered Compound Derivative Object. Besides customarily used cutting and pasting, the authenticated client application may also assist the user in altering groups of attributes using predefined operation macros or templates. For instance, a simple sequence of mouse or keyboard actions may format the page layout of the Derivative Object or Compound Derivative Object effecting many of the components of the Derivative Object or Compound Derivative Object.

The component set is then transferred, in processing block 330, to the derivative object server 115 where the component set is stored in the derivative object database. In processing block 335, the associated Derivative Object or Compound Derivative Object is updated.

In another embodiment, the Derivative Object or a Compound Derivative Object is created with preliminary component set at the authenticated user terminal 120. Therefore, processing block 315 performing the transfer of the Derivative Object or a Compound Derivative Object with a preliminary component set from the derivative object server 115 to the first authenticated user terminal 120 is not necessary.

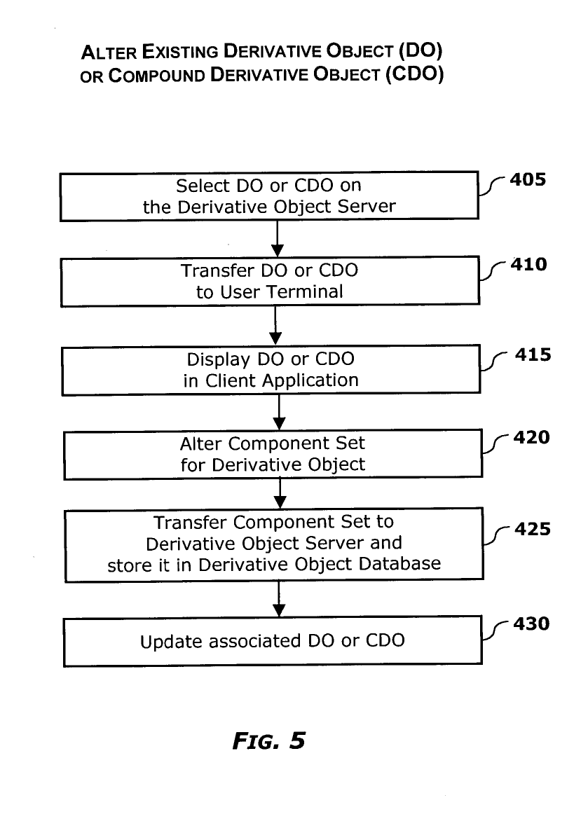

FIG. 5 depicts a flow diagram of one embodiment of a process for allowing an existing Derivative Object (DO) or a Compound Derivative Object (CDO) by user-generated components. The process is performed by processing logic that may comprise hardware, e.g. circuitry and/or dedicated logic, software, such as is run on a general purpose computer system or a dedicated machine, or a combination of both.

The process involves the authenticated user terminal 120, and the derivative object server 115, interconnected through the network 125.

At least one Derivative Object residing on the derivative object server 115 is selected in processing block 405 and it is transferred in processing block 410 to the first authenticated user terminal 120 where it is displayed in processing block 415.

In processing block 420, through commonly used procedures known in the art, the user is allowed to alter, e.g. change, delete from or add to, some or all of the components of the existing component set for the Derivative Object or Compound Derivative Object. For instance, mouse or keyboard actions can display one or more text components of the object inside editable field or fields, where the user can alter or add to the displayed text, including, but not limited to, the title of the object, its caption, subtitle, abstract, detailed text description, personal comments, universal resource locator (URL) or other text components. Applying further commonly used processes, the user may also add other, non-text components, including, but not limited to, quality rating measures, illustration, animated sequences or audio assets selected from server-side or client-side libraries. When the object currently altered is a Compound Derivative Object, the user may define one or more other Derivative Objects or Compound Derivative Objects to be included in the currently altered Compound Derivative Object. Besides customarily used cutting and pasting the authenticated client application may also assist the user in altering groups of attributes using predefined operation macros or templates. For instance, a simple sequence of mouse or keyboard actions may format the page layout of the Derivative Object or Compound Derivative Object effecting many of the components of the Derivative Object or Compound Derivative Object.

The component set is then transferred, in processing block 425, to the derivative object server 115 where the component set is stored in the derivative object database. In processing block 430, the associated derivative Object or Compound Derivative Object is updated according to the newly altered component set.

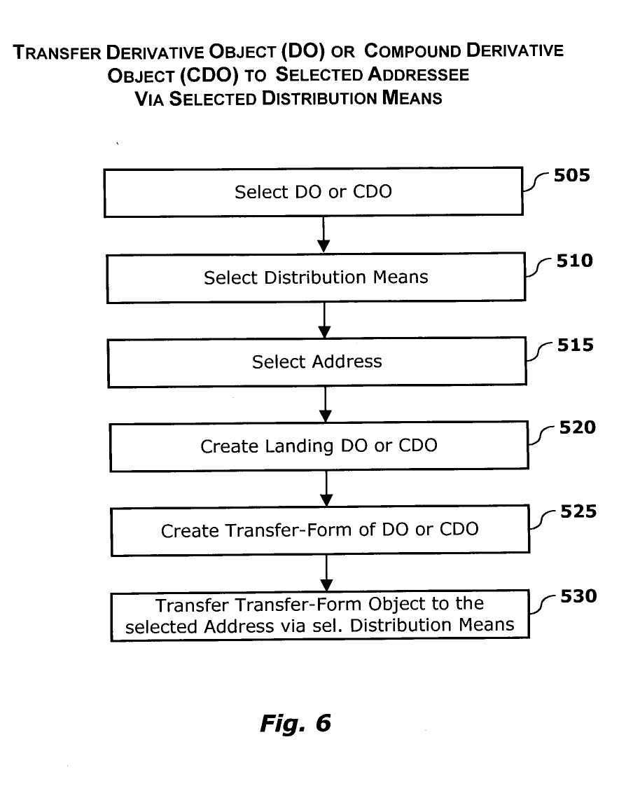

FIG. 6 depicts a flow diagram of one embodiment of a process for transferring of a Derivative Object (DO) or Compound Derivative Object (CDO) to one or more selected addressees via selected distribution mechanisms.

In processing block 505 the Derivative Object or Compound Derivative Object is selected for transfer to an addressee. In processing block 510, the desired selected distribution mechanisms is selected and in processing block 515 the addressee is identified. The choice of distribution mechanisms may include one or more formats, commonly used for digital network-based communication, including, but not limited to, electronic mail (e-mail), various formats of instant messaging systems (IM), publicly available on-line bulletin boards (BB), network-based shared file systems (copytemp), telephone-delivered voice mail (VM), small messaging systems (SMS) delivered by digital telephone systems, most often by wireless systems like cellular phones, and others. In processing block 520 a Landing Derivative Object or Landing Compound Derivative Object is created at the derivative object server 115 and made accessible for the users of the network 125. In processing block 525, the Transfer-Form Derivative Object or Transfer-Form Compound Derivative Object is created. In processing block 530, the Transfer-Form Object is delivered through the selected distribution mechanisms to the addressee.

Using the teachings described herein, users may be put in contact with other users and communicate about and transfer to each-other media objects. The system is built on the top of existing Internet technology to enable users to store, share, communicate about and exchange content, opinions, and whatever they think is interesting freely. Unlike traditional advertising-based networks where advertising gets pushed onto people, the invention creates a relaxed and easy communication-based network where users are put in charge. Users like it and, as a result, advertisers get a more efficient distribution network as well as high, endorsement-based viewer visits. Because the system is user driven it also can tells the operation of the system what is popular among the users and why. This gives the operator both efficient cost-per-click advertising revenues and subscription-based research revenues.

The description below outlines one use of the teachings described herein within the on-line Internet advertising field. As this will be seen from the section following this, the teachings set forth herein can also be used in many other different areas, for instance finance, commerce, education, entertainment, defense, and others. Also, the teachings set forth herein can be implemented on networked devices in general, so the discussion of the Internet implementation here merely to provide a concrete example of the possible implementations.

The use of the teachings set forth herein can primarily enable and market an electronic word of mouth system. The service is end-to-end electronic word of mouth, in this example, an Internet advertising system that combines digital media with communication systems. The service integrates many existing internet services with a new element of creating, experiencing, storing, and distributing either branded or unbranded digital media objects or derivative digital objects, which are representations of single or compound media objects, transferred by electronic communication means to an addressee's receiver device (terminal). Through the creation, use and exchange of media objects an advertiser benefits by the exposure and potential visit to its Web site. In each media object a viewer has the opportunity, before forwarding the object to other users, to attach and include their own thoughts, comments or insights to the object. The system tracks the use and distribution of each media object and can provide usage information to both advertisers and users. Advertiser paid-for media objects are tracked and monitored leaving special marketing-oriented data trail. Advertisers, users and others are charged for a series of services including the creation of media objects, distribution of media objects, usage data, other types of marketing data, a series of advertising-based charges such as cost-per-page view, banners, online placement, and integration-based services as well as any offline marketing services. Services are charged for on either a monthly retainer or subscription-based service or as one-time marketing service agreements. The service can be made available to any legally operating Web site. The use of such service results in the creation, storage, and manipulation of user data. From a service viewpoint, the user data provide a wealth of information indicating, but not limited to, user preferences, trends, popularity of content, commonly accessed URLs, and user email and instant message addresses. From a business standpoint, the data allow the opportunity to share with users and customers certain elements of the data for a fee. Use of such service does not constitute an endorsement of any service or Web site.

Many industries can benefit from the ability to create and distribute pre-packaged and branded media objects and manage an electronic word of mouth advertising method. Note that in each example a viewer can choose to view all or a portion of the media object and, in each case, has the opportunity to include their own insights, comments, and thoughts to the object before choosing to just close it or pass it on to another or several others. The following are several examples of the use of the methodology.

Publishing

1) Journalism

Multi-source Journalism: Because a compound media object carries multiple links, publishers—either individual or business—can create compound multi-source journalistic media objects to cover a particular event, story or issue. An example is creating a compound media object involving the current war on terrorism. The compound object contains a link to a print story from a weekly news magazine's Web-based article about recently discovered video tapes, a link to an earlier video interview with some of the military figures, a link to another story with differing perspective from a newspaper, a link to a recently discovered audio recording, and a link to another story with differing perspective from some of the opponents' news agencies.

2) Two-Way Interactive Publishing System

Publishers are able to track the use and distribution of their media through subscribing to the data/research component of the system. Each distribution of their URL through our service is tracked and recorded. This provides feedback to the publisher as to which articles people found relevant to forward onto others, as well as how often those articles were again forwarded onto to others. This activity also shows to publishers the numbers of new visitors and page views generated from the system.

3) Newsletters and Updates, Changes to Publications

Publishers of newsletters can email or IM compound versions of their newsletters to subscribers making them easy to forward either the entire or portions of the newsletters to other interested parties. Publishers can send updates and changes of existing publications to subscribers through the system. Each change or addition is converted into a specific element of the object. As a subscriber clicks on each change the page loads, making copying and pasting of the changes and updates easy.

4) Presentations and Reports

Every business creates presentations and reports and often the information people use within these reports is found on the Internet or the firm's Intranet. Employees can create compound reports consisting of Web links to present and distribute their ideas. This also creates a very easy format for others to pass the report along to other employees.

5) Product Sales Information

Many companies promote their products on the Internet. However, when a potential customer arrives at the site they often have to navigate through several pages and links to find the product they are looking for. The system described herein quickly and easily enables a salesperson or customer service representative to send directly to a customer the links to the pages for which they are looking. Often, when speaking with a customer service representative they provide you navigational tips because they are-essentially helping a user get what he wants off of their Web site. Several prepackaged objects could be created to email or IM directly to customers for frequently asked questions.

6) Internal Communications

Communicating effectively with employees is a goal of all companies. Often companies set up intranets and also use the Internet to communicate more effectively. Companies can create compound digital media objects to help new employees register for their benefits, learn about the company history, learn of company holidays, etc. . . . Often just referring them to the intranet or their Web site is not effective, people get overwhelmed and distracted. Sending them objects that directly link them to important information is more specific and trackable.

7) Order Confirmation

Each order that a company ships to a customer can be confirmed and managed through the system. On the day the order is scheduled to arrive a compound media object is sent via IM or email to the customer. Within the object, for example, is an order confirmation, a thank you to the customer, and an invitation and special incentive or electronic coupon to order again.

8) Personal Web Publishing, or Blogging Using a Collection of Flyers.

Web logs of Blogs have become a popular application on the Internet. They are Internet journals of personal notes, observations, and Web links—sort of online diaries. When a blogger creates a new entry and posts it to their blog, the entry appears on the top of the web page, which signifies to a reader that it is the most recent entry to the blog. This new entry may or may not be related to the previous entry. The remaining entries fall chronologically down the page. Each entry usually includes a thought and a web link and remains as an independent entry often with a line in between it and other entries. To create a blog using flyers the author creates a sequence of flyers possibly adding to each one intermediary text or segue in form of annotation. Other users are able to view, share, comment, and vote upon each individual flyer or the entire collection or blog of flyers. Flyers are interchangeable and flexible and therefore function as building blocks.

In addition to the customary functionality of the static blogs, the method described here provides added benefits because flyers can also be individually transferred via email or other distribution means, and such spreading of the information from one user to another promotes just the most important piece of information included in the blog. Also, flyers serve as convenient entry point to the blog for whoever clicks upon them

Government

1) Taxes

Every year people log on to IRS.gov to find information and tax forms. The IRS can make this easier by sending out compound media objects in response to compound questionnaire objects to email and IM lists. The compound media objects are created automatically as indicated by the responses to the questionnaire. They could also create and distribute media objects for 1040EZ and 1040, etc. Tax receipts could be collected earlier if the IRS proactively distributed these objects earlier in the tax season, prompting people to complete their taxes. The government processes millions of information requests a year—often to frequently asked questions. The government could also create a searchable database of compound media objects to their most frequently asked questions. These compound media objects would more simply and directly answer people's questions by providing them links to specific answers.

2) Homeland Security

The Office of Homeland Security has established a color-coded alerting system indicating the current level of threat within the United States. The office could create compound media objects and IM or email them to subscribers whenever there is a change of level of alert linking them to a variety of relevant Web sites quickly bringing interested people up to date immediately. The same could be done for the Emergency Broadcast System for weather and security alerts.

3) Military

The U.S. military could help boost their recruiting efforts and information distribution to creating compound media objects to distribute to subscribers and those interested in military matters. Calls for contracts could be distributed easily as well as frequent updates to potential recruits about opportunities could be quickly distributed via IM. Army buffs could easily trade objects with each other over the Internet relating to recent developments or new weapons relating to the U.S. Army.

Health

1) Drug Information, Health Information

Drug companies could create compound objects and send them directly to subscribing doctors or patients by offering new information or updates relating to their products and services. Health information professionals could quickly provide health alerts to people. Often people with similar health problems congregate together on the Internet. A few, well-placed media objects could quickly spread to others who have similar symptoms or illnesses.

People concerned with health and safety information could easily be kept up to speed by subscribing to an IM or email list and receiving compound media objects. For example, if there is an outbreak of the E. coli bacteria subscribers would be sent an immediate IM or email alerting them of the outbreak and also including news reports, press releases, links to the food processors where the outbreak occurred, etc. The media object would quickly make its way across the Internet to those interested and affected by the information.

2) Appointment Reminders

Doctor appointment reminders could be included in compound media objects that remind patients of appointments, maps, and addresses for the office, a reminder of what the patient should/should not do leading up to tests and what to do afterwards, etc.

Educational

1) Homework

A compound object of homework assignments due could be sent to parents with links included to Web sites, e.g. reference, news, libraries, helpful in completing assignments.

2) Application Information and Alumni Groups

Interested applicants could get applications, links to testing sites, links to sample essays, links alumni groups, etc. through a compound object. Alums could get objects to forward to potential applicants that refer them to the school—something of an invitation. Also, universities maintain email lists, and in the future IM lists, of the alums and can send them compound media objects based on their interests in the University. A compound media object is automatically created to alert alums on recent developments or news related to the school they attended, the sports team, university research, fund raising developments, special tickets offers to games, links to news items, etc. Alums could then send them around to other alums/friends.

Financial

1) Corporate Annual Reports, Financial and Investor Information

Companies could create introductory media objects to send to prospective investors and employees. These could be sent to brokers, headhunters, and others interested in communicating about the company to someone. Companies can IM or email compound versions of their annual reports to lists of shareholders and potential investors. Each media element would highlight a specific topic of the company such as holdings, financials, return of investment, a video clip for the CEO, and a proxy for voting.

Detailed investing alerts sent either via IM or email could quickly show someone not only that the price of a share has changed but why it changed and allow them to let others who may want to know more efficiently.

Clubs

1) Dating

People could create their own media object and forward it around the Internet to potential suitors/dates. People could then forward them onto their friends they may think interested.

2) Fan Clubs

Fan clubs with email and IM membership lists could publish special compound media objects alerting fans to upcoming tour dates, movies or television programming featuring the focus of the fans attention. Included with the initial distribution of the object could be limited edition electronic coupons and/or offers for advanced ticket sales or VIP passes allowing fans special media or access to the actor/singer/celebrity.

Personal

1) Resumes

Personal edition media objects could be created and distributed to highlight an individuals career accomplishments and links to sites relevant to their career.

Political

1) Candidate and Party Issues, Voter Reminder

Political candidates have often used mail as a way to reach people loyal to the candidate or party. Candidates could create and distribute through email and IM list compound media objects highlighting the politicians career and accomplishments, voting record, political record, links to the candidates party, information on voting, etc. . . . in turn, supporters of the candidate could then forward these objects on to others within their circle of friends and correspondents that they think may be interested in learning such political information. Candidates could send special IM alerts reminding people to vote and including information as to what and who to vote for, where to vote and other political information.

Religious

1) Platforms, Positions, Newsletters, Membership

Places of worship could create and distribute compound media objects promoting services, events, fundraisers, positions and news. Links to the place of worship or other belief-oriented sites could be included within the media object.

Shopping

1) Electronic Coupon Distribution

Stores could send electronic coupons and special offers to subscribers of email or IM lists—then subscribers could use their electronic purchase card (example: Safeway card) or show their ID when redeeming electronic coupon printed from computer. The media object would include the special offers to subscribers and would link directly to either the stores or vendors site. The electronic coupon would be included in the media object which, although could be forwarded, would include the name of the recipient (requiring ID or savings card) for redemption.

2) Classified Ads

Millions of classified ads are packaged up and displayed everyday in newspapers and on the Internet. Compound media objects consisting of the ad itself and multiple informative links could be easily created and distributed across the Internet and then forwarded onto to other people who may be interested. This also applies to such items as auction notices and other announcements.

Flyers

A further embodiment of the invention provides a network-based system that allows creation, storage and distribution of digital objects that employ a flyer or postcard metaphor. The flyer is a compound digital object that may include: descriptive text elements, illustrative images, numeric descriptors, and other possible digital components. Additionally the flyers may be standalone, or a leading flyer may be associated with one or more fleet member flyers that are united by a common theme. The flyer may be branded, exposing viewers to the publisher's name, likeness, logo, etc. as they manipulate and interact with the flyer. The flyer incorporates personal customization features, wherein a sender may attach personal notes, ratings and category labels. When received, the sender's identity is revealed to the recipient, creating the perception in the recipient of a personal endorsement of the publisher from the sender. Flyers are created by capturing content from Web pages and are stored in a personal publishing area on the system server. Flyers are distributed and propagated using various means of electronic distribution available from the network.

Thus, the invention also provides a generalized tool for information publishing and personal communications that is not limited to a dedicated purpose and that may be invoked without the need to access a specific Web site. The presently preferred embodiment of the invention w which supports the use of flyers, as described above and greater detail below, comprises an information publishing and personal communication system that is implemented on an electronic information network, such as the Internet, using protocols associated with the World Wide Web, such as TCP/IP, and using such languages as HTML, XML, and/or JavaScript.

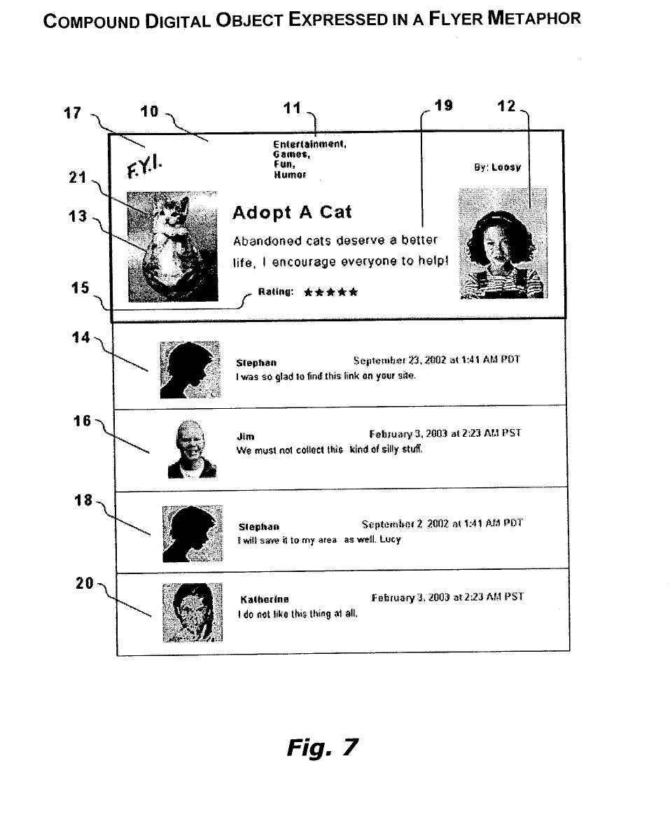

FIG. 7 is a schematic representation of a compound digital object according to the invention. A key component of this embodiment of the invention is the compound digital object 10, referred to herein as a Flyer, and formed by digital components that comprise any of descriptive text elements, illustrative images, numeric descriptors, and other digital elements. The Flyer comprises, for example, a Primary Link which is used to direct a recipient to referred content, such as a Web page or file. The Flyer itself thus presents a visual collection of digital components, organized around a common metaphor, such as a handbill, and generalizable for any desired communication. Thus, in the example of FIG. 7 a young girl, Loosy, is sending information to her friends concerning an Adopt-A-Cat organization. The information contains a piece of the Adopt-A-Cat Web site that Loosy has pasted into her Flyer, along with her picture, and a Headline 17, i.e. “FYI.”

Flyers are stored in one or more databases on the network, for example as described in detail above. Thus, those aspects of the invention described above in connection with digital objects apply as well to Flyers. For example, the user who creates the Flyer, i.e. the Publisher, may decide whether the Flyer is handled in public manner, and thus stored in a way that makes the Flyer available for every user of the system, or is kept confidential and accessible only to the publisher or others explicitly authorized by the Publisher. The Publisher is identified on the Flyer by a Publisher Link 12. The Publisher Link is shown on FIG. 7 as a photo of the Publisher and the Publisher's name, here “Loosy.”

Users who have access to a Flyer, whether or not they are the publishers of such Flyer, can send it to others by using various means of electronic distribution available through the network. Each recipient may annotate the Flyer 14, 16, 18, 20, such that the Flyer becomes a dynamic bulletin board which, in contrast to a known bulletin board that must be visited at a fixed address, can be forwarded endlessly from user to user, accumulating annotations in the process. Recipients may also rate the information, and a cumulated rating 15 is displayed for use by further recipients in evaluating the information.

The Flyer may include any number of labels which are useful in indexing the Flyer. In FIG. 2, Labels include Entertainment, Games, Fun, Humor. Such labels provide a collection of indexing terms. Those skilled in the art will appreciate that other labels may be used and that both user-generated and canned labels may be provided, the latter being provided, for example, in a pull-down list.

Functions of the Flyer

Quick Reference Functions

Introduction

The Flyer's Headline, its Description 19, and its Illustration 21 create an impression that introduces the Flyer's theme to the viewer. The theme is often discussed or presented in more detail at another Web site, Web page, or other Web content depository accessible through the network (Referred Content) via a link 13.

Connection

The Flyer's Primary Link 13 associated with its Headline and/or Illustration provides the viewer with direct access to the Referred Content. The Flyer's Publisher Link 12 provides a convenient way for contacting the Publisher.

Branding Function

Representation

The Flyer may carry its publisher's branding, such as its name, likeness, logo, or other distinguishing mark. In FIG. 2, the Publisher, Loosy, has included her photograph. While manipulating the Flyer, viewers are exposed to these marks or personae and become aware of the Publisher's brand.

Associative Function

Fleeting

A Flyer may stand alone, but the publisher may also associate other Flyers to it. The fleet formed by the Leading Flyer and the Fleet Member Flyers is usually united by some common theme and may serve as a compound device to illustrate or discuss complex themes, create extended classification systems, etc.

Associative Links

Besides its Primary Link to the Referred Content, the Flyer may provide the viewer with multiple links to other types of flyers, for example:

The Publisher Link, which connects the viewer to the fleets of Flyers created by the same publisher.

Commentator Links, which lead to the Flyers of any sender or recipient who attached a personal note or opinion to this Flyer previously.

Category links, which lead to other Flyers that are marked by similar Category Labels (discussed below).

Distributive Function

Propagation: A user of the invention may instruct it to send any Flyer accessible to the sender to one or more recipients on the network, whether or not these recipients are currently users of the system.

Distribution Forms: Distribution through the network may take place by various electronic means. Users of the system may take advantage of the system's Internal Distribution mechanism. But Flyers can also be sent to other recipients by other means, for example via E-mail, various types of instant messengers, telephone (SMS) etc. (External Distribution).

Formatting: The amount of information included within the Flyer at distribution time, as well as its delivery format, are shaped by the system in such a way that they fit the capabilities of the communication channel used for the distribution (Transfer-Form Flyer).

PERSONAL CUSTOMIZATION FUNCTIONS

Information Pockets

The Flyer is equipped with various kinds of information pockets that can be filled not only by the Flyer's original publisher, but also by any sender or recipient.

The Note Keeping System allows any user who has access to the Flyer to attach personal notes to it. The note can be made public for every other user or kept private for the eyes of the original publisher only.

The Rating System accepts votes from any sender or recipient and keeps a summarized rating associated with the Flyer.

Category Labels can be attached to indicate the preferred classification of the Flyer within the universe of Flyers. These labels, defined by the publisher or other users, also serve as automatic search terms that produce lists of all other Flyers marked by similar Category Label.

Personal Endorsement Function

When a Flyer is transferred by a sender to a recipient through the system, the sender's user identity is revealed to the recipient. The sender's user name, likeness, and branding are included alongside the transferred Flyer. This way the addressee receives the transfer as a personal message endorsed by the sender, rather than a piece of impersonal bulk or junk mail.

Making and Organizing Flyers

Making a Flyer by Capturing Components of the Referred Content

Once the invention client software is properly installed on a client computer, a user can make a Flyer based on any Web page and store it in a personal publishing area in the system by making only two gestures, e.g.:

Move the cursor over a representative illustration on the Web page and click the Right Mouse Button; and

Click on the MAKE FLYER entry in the pop-up menu.

As a result, the system automatically captures the title and the URL of the Web page and/or Web page element, and adds a thumbnail-size version of the selected image to the newly-made Flyer.

Making a Flyer from Scratch

To create a Flyer from scratch or modify the information components captured in an existing Flyer, a user may modify the captured information or enter additional information components, for instance text descriptions, category labels, and storage destination instructions.

Reviewing and Organizing Flyers

A user may click the Right Mouse Button and choose the SEE FLYERS entry in the pop-up menu. This takes him inside the F.Y.I. system where he can review, edit, systematize, publish, or transfer his Flyers, or review Flyers published by others.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. In an apparatus for creation, storage, and distribution of digital objects on an electronic information network, a generalized tool for information publishing and personal communications comprising:
a compound digital object, expressed in a flyer metaphor, defining either of a stand alone flyer, and a leading flyer that is associated with at least one fleet member flyer, comprising any of descriptive text elements, illustrative images, numeric descriptors, content excerpts, link to referred content, category label, association link and other digital components; and
said compound digital object comprising means for exposing a viewer to any of a name, likeness, logo, message, link and other characteristics of any of the publisher and a sender of said flyer as said viewer manipulates and interacts with said flyer.

2. The apparatus of claim 1, further comprising:
means for capturing in the form of a compound digital object a portion of content accessible through said electronic information network;
means for storing said compound digital object in a user storage area on a network server;
means for adding to said compound digital object any of a name, likeness, link, logo and other identifier of any of the publisher and a sender for revealing such identity to a recipient when said flyer is received; and
means for sending said compound digital object via said electronic information network.

3. A compound digital object expressed in a flyer metaphor, defining either of a stand alone flyer, and a leading flyer that is associated with at least one fleet member flyer, comprising:
any of descriptive text elements, illustrative images, numeric descriptors, content excerpts, link to referred content, category label, association link and other digital components; and
means for exposing a viewer to any of a name, likeness, logo, message, link and other characteristics of any of the publisher and a sender of said flyer as said viewer manipulates and interacts with said flyer.

4. The compound digital object of claim 3, further comprising:
means for allowing said publisher to decide whether said flyer is handled in a public manner and, if so, storing said flyer in a way that makes said flyer available for every user, or is kept confidential and accessible only to said publisher and others explicitly authorized by said publisher.

5. The compound digital object of claim 3, wherein users who have access to a flyer, whether or not they are the publishers of said flyer, can send it to others.

6. The compound digital object of claim 3, further comprising:
means for each with access to said flyer to annotate said flyer, wherein said flyer becomes a dynamic bulletin board accumulating annotations.

7. The compound digital object of claim 3, further comprising:
means for each with access to said flyer to rate information within said flyer, and for displaying a cumulated rating for use by further having access to said flyer in evaluating said information.

8. The compound digital object of claim 3, further comprising:
a plurality of links to other flyers accessible for users via the electronic information network.

9. The compound digital object of claim 3, said flyer comprising any of: descriptive text element, illustrative image and content excerpts, wherein said flyer creates an impression that introduces said flyer's theme to the viewer.

10. The compound digital object of claim 9, wherein said theme comprises referred content that is available at a content depository accessible via a link.

11. The compound digital object of claim 10, wherein said link is associated with any of said descriptive text element, illustrative image and content excerpts to provide a viewer with direct access to said referred content.

12. The compound digital object of claim 3, wherein said flyer is stand alone.

13. The compound digital object of claim 3, further comprising:
means for said publisher to associate other flyers to a flyer to form a fleet, comprised of a leading flyer and at least one fleet member flyer, wherein said fleet is united by a common theme and optionally serves as a compound device.

14. The compound digital object of claim 3, comprising:
a plurality of links to other flyers, which links may comprise any of:
a publisher link for connecting a viewer to fleets of flyers created by a same publisher;
a commentator link for leading to fleets of flyers of any sender or recipient who attached a personal note or opinion to said flyer previously;
a category link for leading to other flyers that are marked by similar category label; and
an association link, associating said flyer with other flyers identified by the publisher, sender or recipient of said flyer.

15. The apparatus of claim 2, further comprising:
propagation means for sending any flyer accessible to a sender to at least one recipient, whether or not said recipient is currently a system user.

16. The apparatus of claim 2, further comprising:
editing means for altering an amount of information included within a flyer's compound digital object.

17. The apparatus of claim 2, further comprising:
formatting means for shaping an amount of information included within a compound digital object of the flyer in such a way that said information corresponds to the capabilities of a communication channel used for distribution of said flyer.

18. The compound digital object of claim 3, further comprising:
an information pocket that can be filled not only by said flyer's original publisher, but also by any sender or recipient.

19. The compound digital object of claim 18, said information pocket comprising any of:
a note keeping system for allowing any user who has access to said flyer to attach personal notes to thereto, wherein said note can either be made public for every other user or be kept private for an original publisher only;
a rating system for accepting votes from any sender or recipient and for keeping a summarized rating associated with said flyer; and
a category label which is attachable to said flyer to indicate a preferred classification of said flyer within a universe of flyers, wherein said label is defined by a publisher or other users and serves as an automatic search term that produces a list of all other flyers marked by a similar category label.

20. A method for making a compound digital object, comprising the steps of:
capturing any of a portion of the referred digital content accessible through the electronic information network, link to said content, thumbnail-size illustration depicting said content, publisher-defined digital content, publisher-defined link;
adding publisher identification comprising of any of a publisher's name, likeness, link, message and logo; and
saving the captured compound digital object on the network server.
